(19) United States
(12) Patent Application Publication
(10) Pub. No.: US 2006/0092576 A1
(43) Pub. Date: May 4, 2006

(54) Magnetic head for high speed data transfer

(75) Inventor: Takayoshi Ohtsu, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/259,431

(22) Filed: Oct. 25, 2005

(30) Foreign Application Priority Data
Oct. 28, 2004 (JP) 2004-314191

(51) Int. Cl. G11B 5/33; G11B 5/127

(52) U.S. Cl. 360/319

(57) ABSTRACT

A read head having superior high frequency response characteristics is needed to achieve high-speed data transfer. Further, in perpendicular magnetic recording, since the read signal has a rectangular waveform, the harmonic components must be properly reproduced, requiring a read head having further improved high frequency read characteristics. A feature of the present invention is to provide a read head with superior high-speed response characteristics which can be applied to a magnetic disk drive to achieve high density and high-speed data transfer. In specific embodiments, the present invention provides a magnetic head having a capacitance of about 2 pF or less. It also provides a magnetic head in which the overlapping area of the upper and lower magnetic shields is about 5300 μm² or less.

### CROSS-REFERENCES TO RELATED APPLICATIONS

This application claims priority from Japanese Patent Application No. JP2004-314191, filed Oct. 28, 2004, the entire disclosure of which is incorporated herein by reference.

### BACKGROUND OF THE INVENTION

The present invention relates to a magnetic head suitable for high-speed data transfer.

A magnetic disk drive uses a magnetic head(s) to write/read data to/from a recording medium(s). Increasing the recording capacity per unit area of the magnetic disk requires increasing the areal density. Further, there has been a need to increase the data transfer speed. To enhance the data transfer speed, it is necessary to improve both the read and write components or mechanisms.

One conventional magnetic head for high-speed data transfer is a read write separation type head such as that disclosed in Japanese Patent Laid-Open No. 5-182145 (1993). This read write separation type head includes an inductive head and a magnetoresistive head as a write head and a read head, respectively. Since the magnetic pole of the write head is formed of a film stack including a main magnetic film and a nonmagnetic film acting as an intermediate layer, the write head exhibits superior write performance at up to high frequencies, which makes it possible to produce a magnetic disk drive capable of achieving high-speed data transfer and high recording density.

Further, Japanese Patent Laid-Open No. 7-85420 (1995) discloses a thin film magnetic head in which the divergence angles of the tips of the upper and lower cores are adjusted so as to reduce the influence of saturation of the head as well as reducing head noise, allowing the head to provide a high data transfer speed, namely 3 MB/s (or 24 Mbps) or more.

Japanese Patent Laid-Open No. 10-208212 (1998) discloses a magnetic head in which the write pole width of the inductive magnetic transducer element is set to a very small value to achieve high areal density and improve the high frequency read output characteristics.

Japanese Patent Laid-Open No. 2000-67401 describes a magnetic read/write device comprising: a magnetic recording medium whose normalized noise factor per transition is in the range of 2.5×10⁻⁸ (μVrms)(inch)(μm)^{0.5}/(μVpp); a magnetic write head with a magnetic path length of 35 μm or less having a magnetic film or a multilayer film in the magnetic path, wherein the magnetic film has a specific resistance of 50 μΩcm or more, wherein the multilayer film includes the magnetic film and an insulating film, and wherein the magnetic head is mounted on a suspension with wiring formed therein to reduce the total inductance to 65 nH or less; and a high-speed R/W-IC having a line width of 0.35 μm or less. This magnetic read/write device can read or write at a high data transfer speed (50 MB/s, or 400 Mbps, or more).

Further, Japanese Patent Laid-Open No. 2003-346306 discloses a magnetic storage device with high recording density including a write head capable of providing sufficient write performance even at high frequencies since the write head includes a magnetic film which is formed of 40-60% Ni—Fe containing Co, Mo, Cr, B, In, Pd, etc by a frame plating technique and which has high saturation magnetic flux density (1.5 T or more) and a specific resistance of 40 μcm or more. This magnetic storage device rotates the magnetic disks at 4000 rpm or more and exhibits a media data transfer speed of 15 MB/s (or 120 Mbps) or more and a write frequency of 45 MHz or more.

### BRIEF SUMMARY OF THE INVENTION

To further increase the data transfer speed, it is necessary to improve the read head as well as the write head. To provide a magnetic disk capable of achieving high density and high-speed data transfer, it is necessary to develop a read head with a narrow read gap having superior read characteristics at high frequencies. Furthermore, a read head having good high frequency response characteristics is needed to provide high-speed data transfer.

In perpendicular magnetic recording, since the read signal has a rectangular waveform, the harmonic components must be properly reproduced, requiring a read head having further improved high frequency read characteristics.

Further, increasing the reading resolution to achieve high density recording requires the read gap length to be reduced. However, the capacitance increases with decreasing read gap length, resulting in degraded high frequency response characteristics. It is, therefore, a feature of the present invention to provide a read head having superior high-speed response characteristics which allows a magnetic disk drive to achieve high density and high-speed data transfer.

To solve the above problems, one aspect of the present invention provides a magnetic head in which the capacitance between the upper and lower magnetic shields is set to about 2 pF or less to achieve high-speed data transfer in longitudinal magnetic recording or perpendicular magnetic recording. Further, another aspect of the present invention provides a magnetic head in which the capacitance between the upper and lower magnetic shields is set to about 1 pF or less to achieve data transfer at higher speed.

It should be noted that when the resistance of the read element is 100 Ωand the capacitance between the terminals is 0.2 pF, the relationship between the read frequency f and the capacitance between the two electrodes is expressed by the equation: f=1/(2π(C_{pad}+C_{MR})R_{MR}), where R_{MR} denotes the resistance of the MR head, C_{MR} denotes the capacitance of the MR head, and C_{pad} denotes the capacitance between the terminals. The capacitance C_{MR}equals the sum of the capacitance C_{μ} between the upper magnetic shield and the positive and negative electrodes and the capacitance C₁ between the lower magnetic shield and the positive and negative electrodes. The frequency band is set to 1.3 times the read frequency. To achieve a data transfer speed of 1 Gbps or more in longitudinal recording, the capacitance must be set to about 2 pF or less. Further, the capacitance must be reduced to about 1 pF or less to provide a data transfer speed of 2 Gbps or more. As for perpendicular magnetic recording, since the read signal has a rectangular waveform, the read band must be wide enough to accommodate up to the third harmonic. Therefore, to achieve a data transfer speed of 400 Mbps or more, the capacitance must be set to about 2 pF or less. Further, the capacitance must be reduced to about 1 pF or less to provide a data transfer speed of 800 Mbps or more.

Further, to achieve such small capacitances, the present invention uses an insulating material having a dielectric constant of about 8 or less for the gap film of the magnetic head or sets the overlapping area of the upper and lower magnetic shields to about 5300 μm². Suitable examples of materials having a dielectric constant of 8 or less include SiO₂, Al₂O₂—SiO₂, Al—O—N, SiAlO—N, AlN, Si₃N₄, diamond, graphite, TaO₅, oxides, nitrides, and nitrided oxides.

The present invention provides a magnetic head having a low capacitance capable of achieving high-speed data transfer when it is incorporated in a magnetic storage device, as well as capable of providing good high-speed response characteristics even in perpendicular magnetic recording.

### BRIEF DESCRIPTION OF THE DRAWINGS

FIG. 1 (including FIGS. 1(a) and 1(b)) is a conceptual diagram showing a magnetic disk drive according to an embodiment of the present invention.

FIG. 2 is an external view of the read head portion of the magnetic head according to an embodiment of the present invention.

FIG. 3 is a cross-sectional view of a magnetic head for longitudinal magnetic recording taken in a direction perpendicular to a radial direction of the magnetic disk.

FIG. 4 is a cross-sectional view of a magnetic head for perpendicular magnetic recording taken in a direction perpendicular to a radial direction of the magnetic disk.

FIG. 5 is a plan view showing conventional magnetic shields.

FIG. 6 is a plan view showing magnetic shields according to a first embodiment of the present invention.

FIG. 7 is a plan view showing magnetic shields according to a second embodiment of the present invention.

FIG. 8 shows the frequency dependence of the allowable maximum capacitance of the read head of a magnetic head.

FIG. 9 shows the relationship between read gap length Gs and the capacitance.

FIG. 10 shows an exemplary relationship between the overlapping area of the upper and lower magnetic shields of a magnetic head and the capacitance, wherein the curve is plotted based on the overlapping area values and the capacitance values of the first and second embodiments.

FIG. 11 shows an exemplary relationship between the film thickness t of upper and lower magnetic shields and the overlapping area S of these magnetic shields.

FIG. 12 shows an exemplary relationship between the dimension W of the overlapping area of upper and lower magnetic shields in the track width direction and the length H of these magnetic shields when the film thickness of the magnetic shields is 3 μm or less.

FIG. 13 shows how the capacitance of a read head depends on the dielectric constant of the insulating material of the magnetic gap film.

FIG. 14 is a diagram showing an electric circuit formed by the read element, electrodes, and upper and lower magnetic shields of a magnetic head of the present invention.

### DETAILED DESCRIPTION OF THE INVENTION

Specific embodiments of the present invention will be described below with reference to the accompanying drawings.

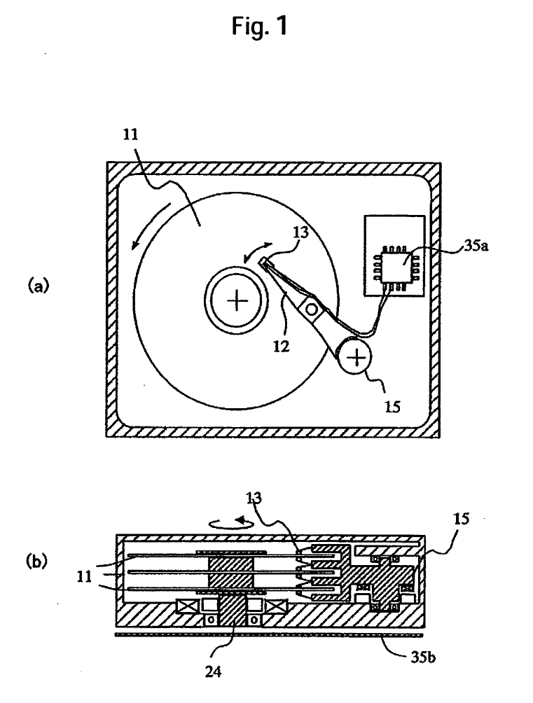

FIG. 1 (including FIGS. 1(a) and 1(b)) is a conceptual diagram showing a magnetic disk drive according to an embodiment of the present invention. The magnetic disk drive writes/reads a magnetization signal to/from a target position on each magnetic disk 11 rotated by a motor 24 by use of a magnetic head mounted on a slider 13 fixed to the tip of a suspension arm 12. A rotary actuator 15 can be driven to move each magnetic head to a target radial position (track) of a magnetic disk. Signal processing circuits 35a and 35b process the write/read signals to/from the magnetic heads.

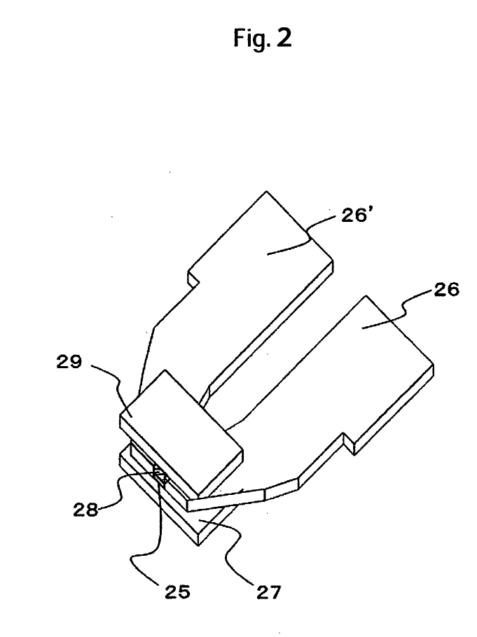

FIG. 2 is an external view of the read head portion of a magnetic head according to an embodiment of the present invention. It should be noted that each magnetic head is composed of a write head for writing to a disk and a read head for reading a signal from the disk. The read head of the present embodiment is formed as follows. First, a read element 25 is formed on a lower magnetic shield 27 formed on a substrate (not shown). Then, a first electrode (positive electrode) 26 and a second electrode (negative electrode) 26′ for supplying a current to the read element 25 are formed on the read element 25, and then a magnetic gap film 28 is formed. After that, an upper magnetic shield 29 is formed on the magnetic gap film 28.

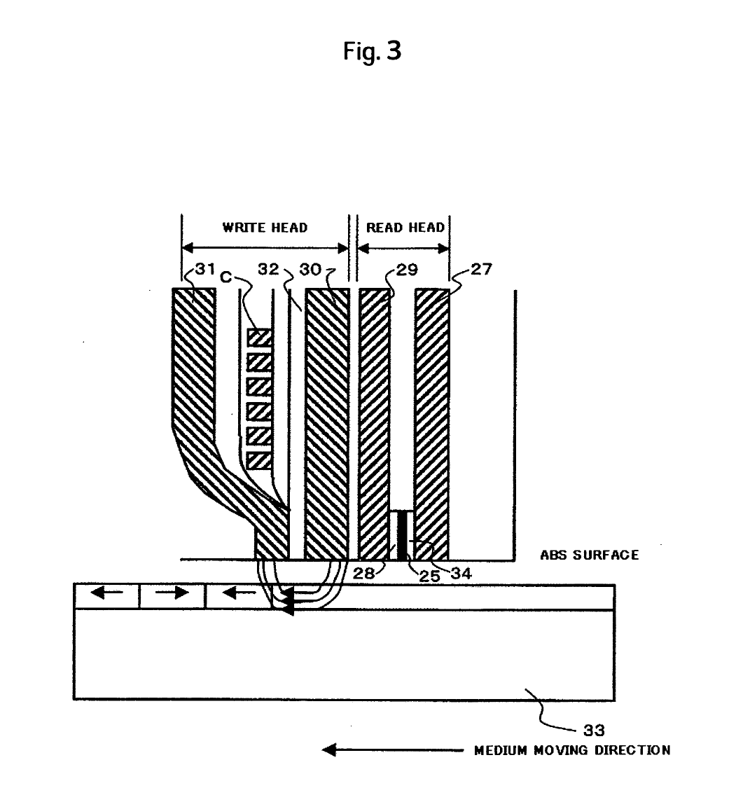

FIG. 3 is a cross-sectional view of a magnetic head for longitudinal magnetic recording taken in a direction perpendicular to a radial direction of the magnetic disk. The read head includes a read element 25 which is formed on a substrate 34 and sandwiched by upper and lower magnetic shields 29 and 27. The write head includes a lower magnetic pole piece 30, an upper magnetic pole piece 31, and a magnetic gap layer 32 sandwiched by the upper and lower magnetic pole pieces 31 and 30, thus forming a magnetic gap on the ABS surface facing a magnetic disk 33. In the case of a write operation in the longitudinal recording system, the magnetic flux leaked from the lower magnetic pole piece 30 magnetizes concentric tracks on the magnetic medium in a longitudinal direction, as shown in FIG. 3. In a read operation, on the other hand, the magnetic flux from a magnetized area on the rotating magnetic medium crosses the read element 25 of the read head, thereby causing a change in the internal resistance of the read element 25.

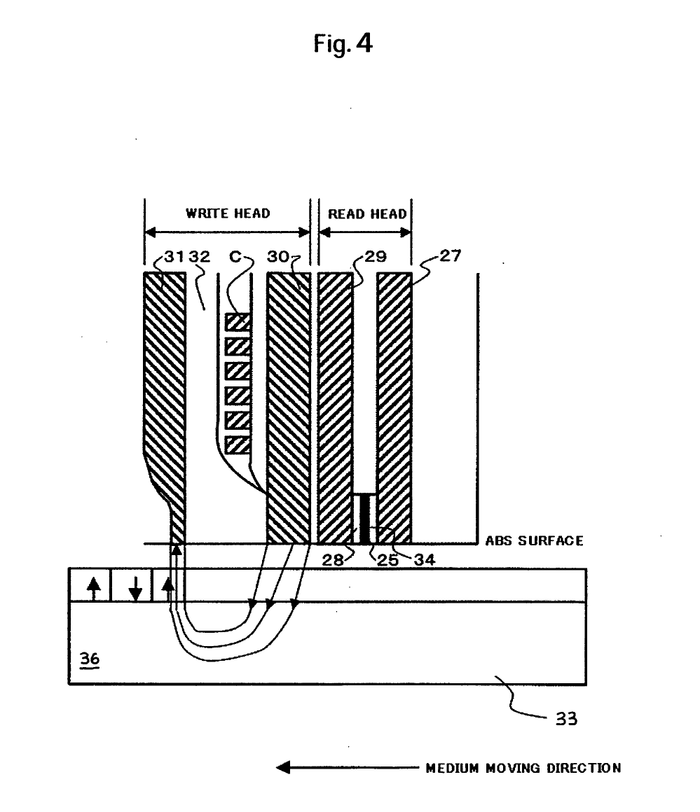

FIG. 4 is a cross-sectional view of a magnetic head for perpendicular magnetic recording taken in a direction perpendicular to a radial direction of the magnetic disk. The read head includes a read element 25 which is formed on a substrate 34 and sandwiched by upper and lower magnetic shields 29 and 27. The write head includes a lower magnetic pole piece 30, an upper magnetic pole piece 31, and a magnetic gap layer 32 sandwiched by the upper and lower magnetic pole pieces 31 and 30, thus forming a magnetic gap on the ABS surface facing a magnetic disk 33. In a write operation, a signal current flows through a coil layer C and a magnetic flux is leaked from the ABS surface. The leaked magnetic flux goes back to the magnetic head through a lower soft magnetic film 36 of the recording medium. This magnetic flux magnetizes concentric tracks on the magnetic medium in a perpendicular direction in write operation. In a read operation, on the other hand, the magnetic flux from a magnetized area on the rotating magnetic medium crosses the read element 25 of the read head, thereby causing a change in the internal resistance of the read element 25. This change in the resistance is detected by detecting a change in the voltage of the read element 25.

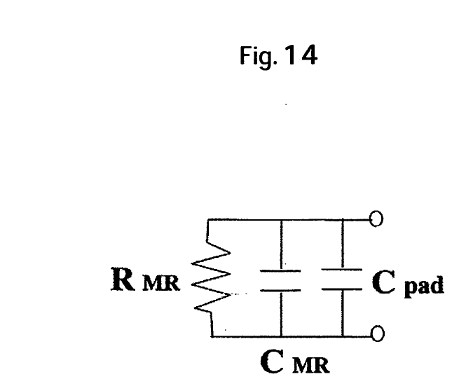

FIG. 14 is a diagram showing an electric circuit formed by the read element, electrodes, and upper and lower magnetic shields of a magnetic head of the present invention. In the figure, R_{MR} denotes the resistance value of the MR head, C_{MR} denotes the capacitance of the MR head, and C_{pad} denotes the capacitance between the terminals. The capacitance C_{MR} equals the sum of the capacitance C_{U} between the upper magnetic shield and the positive and negative electrodes and the capacitance C₁ between the lower magnetic shield and the positive and negative electrodes. The read frequency f is expressed by the equation: f=1/(2π(C_{pad}+C_{MR})R_{MR}). It should be noted that the sum of C_{pad}+C_{MR}, which represents the capacitance between the two electrodes, is given by the equation: (C_{pad}+C_{MR})=Sε/d, where S denotes the overlapping area of the upper and lower magnetic shields, ε denotes the dielectric constant of the gap material of the magnetic gap film, and d denotes the distance between the upper and lower magnetic shields. The above equations imply that to increase the read frequency, the capacitance (C_{pad}+C_{MR}) between the upper and lower magnetic shields must be reduced, which requires reducing the overlapping area of the upper and lower magnetic shields or reducing the dielectric constant.

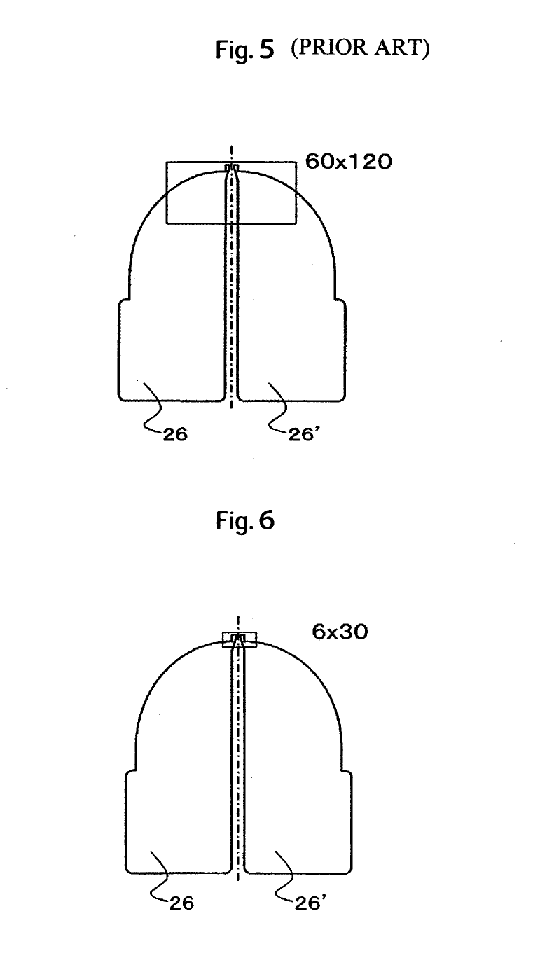

FIG. 5 is a plan view showing conventional magnetic shields (and electrodes). Specifically, the figure shows the overlapping area of conventional upper and lower magnetic shields. The dimension (of the overlapping area) of the magnetic shields in the track width direction is 120 μm, while that in the stripe height direction (or the length of the magnetic shields) is 60 μm. The gap material is Al₂O₃. Further, the distance between the upper and lower magnetic shields is 70 nm, the capacitance is 2.4 pF, and the thickness of the magnetic shields is 3 μm.

A description will be given below of magnetic shields according to specific embodiments of the present invention with reference to their plan views.

FIG. 6 is a plan view showing magnetic shields according to a first embodiment of the present invention. The dimension (of the overlapping area) of the magnetic shields in the track width direction is 30 μm, while that in the stripe height direction (or the length of the magnetic shields) is 6 μm. These dimensions are considerably smaller than those of the conventional magnetic shields. The gap material is SiO₂—containing Al₂O₃, which has a lower dielectric constant than Al₂O₃ containing no additives. The distance between the upper and lower magnetic shields, that is, the gap length, is set to 60 nm to achieve high-density recording. In this case, the capacitance is 0.7 pF and the film thickness of the magnetic shields is 1 μm.

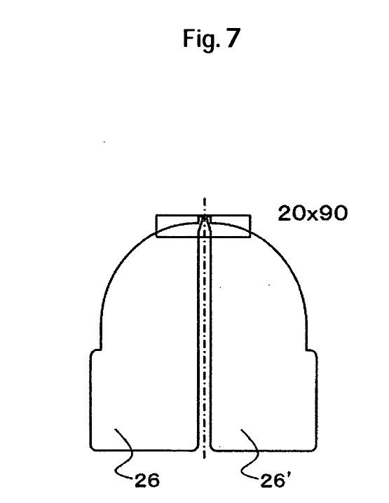

FIG. 7 is a plan view showing magnetic shields according to a second embodiment of the present invention. The dimension (of the overlapping area) of the magnetic shields in the track width direction is 90 μm, while that in the stripe height direction is 20 μm. The gap material is SiO₂—containing Al₂O₃, which has a lower dielectric constant than Al₂O₃ containing no additives. The gap length is set to 60 nm to achieve high-density recording. In this case, the capacitance is 0.97 pF and the film thickness of the magnetic shields is 1 μm.

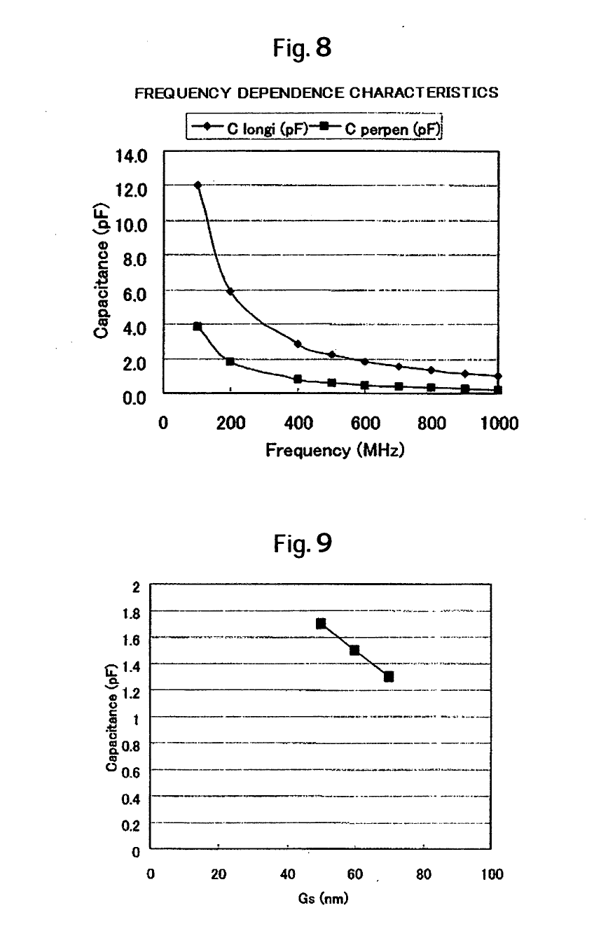

FIG. 8 shows the frequency dependence of the allowable maximum capacitance of the read head of a magnetic head such as that described above. The horizontal axis represents the read/write frequency while the vertical axis represents the allowable maximum capacitance of the read head. The figure indicates that to achieve a frequency of 200 MHz in longitudinal magnetic recording, the capacitance of the read head must be set to about 6 pF or less. The allowable maximum capacitance of the read head decreases with increasing frequency. That is, for example, the capacitance of a read head for longitudinal recording must be set to about 2 pF or less to achieve a frequency of 500 MHz or more (corresponding to a data transfer speed of 1 Gbps or more). The frequency dependence curve for longitudinal magnetic recording shown in FIG. 8 satisfies the equation: Y=1690/X^{1.0685}, where Y is the capacitance and X is the frequency.

In perpendicular recording, since the read signal has a rectangular waveform, reproducing the waveform requires a frequency band 3 times wider than that required in longitudinal recording. This means that it is necessary to further reduce the capacitance of the read head. Therefore, for example, to achieve a frequency of 200 MHz or more (corresponding to a data transfer speed of 400 Mbps or more), the capacitance of a read head for perpendicular recording must be set to about 2 pF or less. Further, a read head for perpendicular recording must have a capacitance of about 1 pF or less to achieve a frequency of 400 MHz or more (corresponding to a data transfer speed of 800 Mbps or more). The frequency dependence curve for perpendicular magnetic recording shown in FIG. 8 satisfies the equation: Y=1393/X^{1.2565}, where Y is the capacitance and X is the frequency.

To increase the recording density, it is necessary to increase the linear recording density as well as the track density. Increasing the linear recording density requires enhancing the reading resolution and reducing the read gap length.

FIG. 9 shows the relationship between the read gap length, Gs, and the capacitance. The figure indicates that a reduction in the read gap length results in an increase in the capacitance. Therefore, reducing the capacitance of the read head is important for providing a magnetic recording device which employs a reduced gap length and the perpendicular recording system to increase the recording density and which achieves high-speed data transfer.

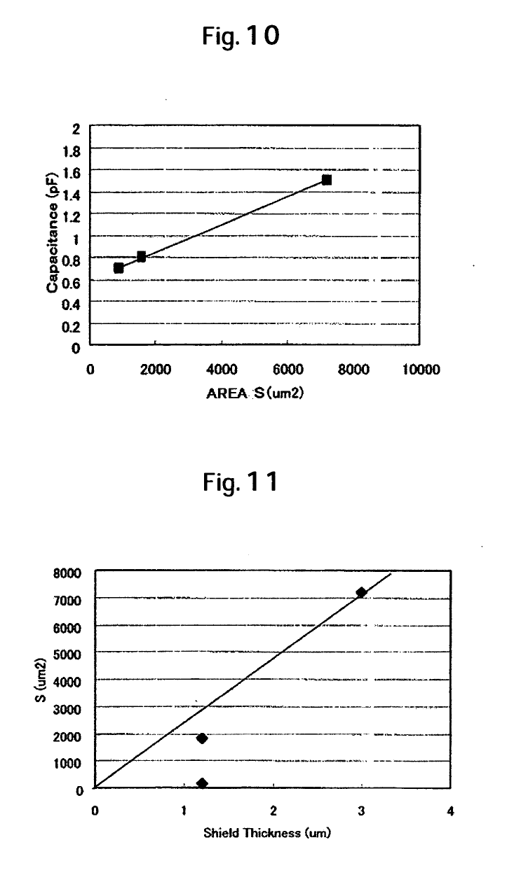

FIG. 10 shows an exemplary relationship between the overlapping area of the upper and lower magnetic shields of a magnetic head and the capacitance. The curve is plotted based on the overlapping area values and the capacitance values of the above first and second embodiments and conventional example. The figure indicates that the capacitance of the read head can be reduced by reducing the area of (the overlapping area of) the magnetic shields. For example, when the overlapping area is about 5300 μm²or less, the capacitance is about 2 pF or less, which makes it possible to achieve a frequency of 500 MHz or more in longitudinal recording or 200 MHz or more in perpendicular recording. Further, the gap material may be formed of SiO₂—containing Al₂O₃ and the overlapping area may be reduced to about 3200 μm² or less to reduce the capacitance to about 1 pF or less, which makes it possible to achieve a frequency of 400 MHz or more in perpendicular recording.

FIG. 11 shows an exemplary relationship between the film thickness t of the upper and lower magnetic shields and the overlapping area S of these magnetic shields. The figure indicates that the ratio of the area S to the film thickness t must be about 2400 or less. According to the present invention, the ratio of the area S to the film thickness t is preferably the same as that of the conventional example in order to ensure sufficient shape anisotropy of the magnetic shields and thereby achieve the required magnetic characteristics.

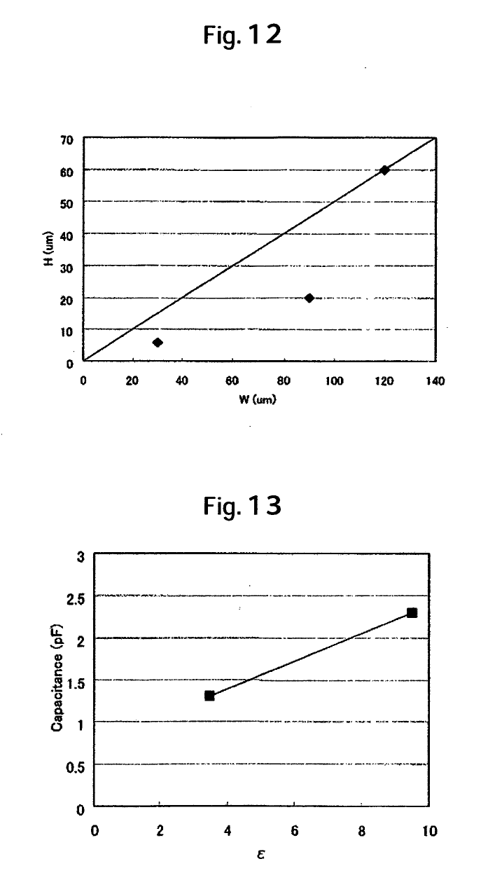

FIG. 12 shows an exemplary relationship between the dimension W of the overlapping area of the upper and lower magnetic shields in the track width direction and the length H of these magnetic shields when the film thickness of the magnetic shields is about 3 μm or less. It should be noted that the film thickness of the magnetic shields is preferably set to about 3 μm or less to prevent the magnetic shields from being projected from the air bearing surface due to their thermal expansion while ensuring that the magnetic shields have sufficient shielding function. The figure indicates that the ratio (H/W) of the length H of the magnetic shields (that is, the dimension in the stripe height direction) to the dimension W in the track width direction is preferably set to about 1 or less, more preferably about ½ or less to ensure sufficient shape anisotropy of the magnetic shields and thereby achieve the required magnetic characteristics.

FIG. 13 shows how the capacitance depends on the dielectric constant of the insulating material of the magnetic gap film. The conventional example uses Al₂O₃ as the insulating material. The dielectric constant of Al₂O₃ containing no additives is 9.5, while that of Al₂O₃ containing SiO₂ is 3.5. This means that the capacitance can be reduced from 2.3 pF to 1.3 pF by using SiO₂—containing Al₂O₃ instead of Al₂O₃ containing no additives, as shown in FIG. 13. Use of an insulating material having a dielectric constant of about 8 or less ensures longitudinal recording at 500 MHz or more or perpendicular recording at 200 MHz or more. Other materials having a dielectric constant of about 8 or less include SiO₂, Al₂O₂—SiO₂, Al—O—N, SiAlO—N, AlN, Si₃N₄, diamond, graphite, TaO₅, oxides, nitrides, and nitrided oxides, which can also produce the above-described effect.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A magnetic head comprising:
a substrate;
a lower magnetic shield formed on said substrate;
a read element formed on said lower magnetic shield;
a first electrode and a second electrode formed on said read element;
a gap film formed on said first and second electrodes; and
an upper magnetic shield formed on said gap film;
wherein a capacitance between said first and second electrodes is about 2 pF or less.

2. The magnetic head as claimed in claim 1, wherein said capacitance is about 1 pF or less.

3. The magnetic head as claimed in claim 1, wherein an overlapping area of said upper and lower magnetic shields is about 5300 μm² or less.

4. The magnetic head as claimed in claim 1, wherein the overlapping area of said upper and lower magnetic shields is about 3200 μm² or less.

5. The magnetic head as claimed in claim 1, wherein a ratio (H/W) of the length H of said upper and lower magnetic shields to the dimension W of the overlapping area of said upper and lower magnetic shields in a track width direction is about 1 or less.

6. The magnetic head as claimed in claim 1, wherein a ratio (H/W) of the length H of said upper and lower magnetic shields to the dimension W of the overlapping area of said upper and lower magnetic shields in a track width direction is about 0.5 or less.

7. The magnetic head as claimed in claim 1, wherein said upper and lower magnetic shields have a film thickness of about 3 μm or less.

8. The magnetic head as claimed in claim 1, wherein a ratio (S/t) of the overlapping area S of said upper and lower magnetic shields to the film thickness t of said upper and lower magnetic shields is about 2400 or less.

9. The magnetic head as claimed in claim 1, wherein said gap film is formed of an insulating material having a dielectric constant of about 8 or less.

10. The magnetic head as claimed in claim 9, wherein the insulating material of said gap film is selected from the group consisting of SiO₂, Al₂O₂—SiO₂, Al—O—N, SiAlO—N, AlN, Si₃N₄, diamond, graphite, TaO₅, oxides, nitrides, and nitrided oxides.

11. The magnetic head as claimed in claim 1, wherein said gap film comprises an insulating material including SiO₂—containing Al₂O₃.
